(19) United States
(12) Patent Application Publication
(10) Pub. No.: US 2008/0222369 A1
(43) Pub. Date: Sep. 11, 2008

(54) Access Control Partitioned Blocks in Shared Memory

(75) Inventor: Jong-Sik Jeong, Seoul (KR)

Correspondence Address: HUSCH BLACKWELL SANDERS LLP, 720 OLIVE STREET, SUITE 2400, ST. LOUIS, MO, 63101, US

(73) Assignee: MTEKVISION CO., LTD., Seoul (KR)

(21) Appl. No.: 11/995,567

(22) PCT Filed: Jun. 13, 2006
(86) PCT No.: PCT/KR06/02256

§ 371 Date: Jan. 14, 2008

(30) Foreign Application Priority Data
Jul. 21, 2005 (KR) 10-2005-0066299

(51) Int. Cl. G06F 12/00

(52) U.S. Cl. 711/153; 711/E12.001

(57) ABSTRACT

A method for controlling multiple access to partitioned areas of a shared memory and a digital processing apparatus having the shared memory are disclosed. According to embodiments of the present invention, the storage area of a shared memory is partitioned to a plurality of storage areas, and each processor accesses a storage area through each access port to store data and transfers an authority to access the pertinent storage area to the other processor, thereby allowing access by the other processor. With the present invention, the data communication time between the plurality of processors can be minimized, and the process efficiency of each processor can be optimized.

### TECHNICAL FIELD

The present invention is directed to a digital processing apparatus, more specifically to a digital processing apparatus having a plurality of processors.

### BACKGROUND ART

A portable terminal refers to a compact electronic device that is designed to be easily carried by a user in order to perform functions such as game or mobile communication. A portable terminal can be a mobile communication terminal, a personal digital assistant (PDA), or a portable multimedia player (PMP).

The mobile communication terminal is essentially a device designed to enable a mobile user to telecommunicate with a receiver who is remotely located. Thanks to scientific development, however, the latest mobile communication terminals have functions, such as camera and multimedia data playback, in addition to the basic functions, such as voice communication, short message service and address book.

FIG. 1 shows a block diagram of a conventional mobile communication terminal having a camera function.

Referring to FIG. 1, the mobile communication terminal 100 having a camera function comprises a high frequency processing unit 110, an analog-to-digital converter 115, a digital-to-analog converter 120, a processing unit 125, a power supply 130, a key input 135, a main memory 140, a display 145, a camera 150, an image processing unit 155 and a support memory 160.

The high frequency processing unit 110 processes a high frequency signal, which is transmitted or received through an antenna.

The analog-to-digital converter 115 converts an analog signal, outputted from the high frequency processing unit 110, to a digital signal and sends to the processing unit 125.

The digital-to-analog converter 120 converts a digital signal, outputted from the processing unit 125, to an analog signal and sends to the high frequency processing unit 110.

The processing unit 125 controls the general operation of the mobile communication terminal 100. The processing unit 125 can comprise a central processing unit (CPU) or a micro-controller.

The power supply 130 supplies electric power required for operating the mobile communication terminal 100. The power supply 130 can be coupled to, for example, an external power source or a battery.

The key input 135 generates key data for, for example, setting various functions or dialing of the mobile communication terminal 100 and sends to the processing unit 125.

The main memory 140 stores an operating system and a variety of data of the mobile communication terminal 100. The main memory 140 can be, for example, a flash memory or an EEPROM (Electrically Erasable Programmable Read Only Memory).

The display 145 displays the operation status of the mobile communication terminal 100 and an external image photographed by the camera 150.

The camera 150 photographs an external image (a photographic subject), and the image processing unit 155 processes the external image photographed by the camera 150. The image processing unit 155 can perform functions such as color interpolation, gamma correction, image quality correction and JPEG encoding. The support memory 160 stores the external image processed by the image processing unit 155.

As described above, the mobile communication terminal 100 having a camera function is equipped with a plurality of processing units (that is, a main processor and one or more application processors for performing additional functions). In other words, as shown in FIG. 1, the processing unit 125 for controlling general functions of the mobile communication terminal 100 and the image processing unit 155 for controlling the camera function are included. The operations of the application processors for additional functions can be controlled by the main processor. Moreover, each processing unit is structured to be coupled with an independent memory.

The application processor can take different forms depending on the kinds of additional functions, with which the portable terminal is equipped. For example, the application processor for controlling the camera function can process functions such as JPEG encoding and JPEG decoding; the application processor for controlling the movie file playback function can process functions such as video file (e.g., MPEG4, DIVX, H.264) encoding and decoding; and the application processor for controlling the music file playback function can process functions such as audio file encoding and decoding. Of course, there can be an application processor that can process various aforementioned functions altogether. Each of these processing units has an individual memory for storing the data processed by the processing unit. Therefore, according to the prior art, it is necessary to increase the number of processing units and memories as portable terminals become increasingly multifunctional.

FIG. 2 illustrates an example of a coupling structure among a main processor, an application processor and their corresponding memories in accordance with the prior art.

Referring to FIG. 2, the main processor 210 and the application processor 220 communicate information through BUS1; the main processor 210 is coupled to the main memory 230 through BUS2; and the application processor 220 is coupled to the supplementary memory 240 through BUS3. A bus refers to a common-purpose electric pathway that is used to transmit information between the processor, the main memory, and the input/output in a device such as a computer. A bus comprises a line for data, designating the address of each device or the location of the memory, and a line for distinguishing a variety of data transmission operation to be processed.

As illustrated in FIG. 2, each of the processors 210 and 220 is independently coupled to each of the memories 230 and 240. Therefore, the main processor 210 reads the data stored in the main memory 230 and transmits the data to the application processor 220 through a host interface or reads the data stored in the supplementary memory 240 by requesting the application processor 220. In other words, in case certain data is processed in the main processor 210 and the application processor 220, respectively, the main processor 210 accesses the main memory 230 to perform a necessary process and then transmits the processed data to the application processor 220, and the application processor 220 re-processes the received data and stores in the supplementary memory 240. Then, the application processor 220 transmits the data stored in the supplementary memory 240 back to the main processor 210 to have it stored in the main memory 230.

In this case, the larger the amount of data, communicated between the main processor 210 and the application processor 220, is, the more time each of the processors 210 and 220 spends on the operation (i.e. memory access, host interface operation) requested by the other processor rather than the operation of its own process.

This problem causes a bottleneck in data communication between the main processor 210 and the application processor 220 as the amount of data to be processed and the functions performed by the portable terminal increase.

As a result, the problems described above weaken the overall performance of a multi-function portable terminal.

### [Disclosure]

### [Technical Problem]

In order to solve the problems described above, it is an object of the present invention to provide a method for controlling multiple access to partitioned blocks of a shared memory and a portable terminal having the shared memory that can minimize the data transmission time between processors, by partitioning the storage area of the shared memory into a plurality of partitioned blocks and allowing the plurality of processors to access each partitioned block.

It is another object of the present invention to provide a method for controlling multiple access to partitioned blocks of a shared memory and a portable terminal having the shared memory that can allow each processor to handle its dedicated process to optimize the operation speed and efficiency of each processor by allowing partitioned storage areas of the shared memory to be accessed by a plurality of processors.

It is yet another object of the present invention to provide a method for controlling multiple access to partitioned blocks of a shared memory and a portable terminal having the shared memory that can easily control the shared memory in software, by using partitioned blocks of the shared memory.

It is still another object of the present invention to provide a method for controlling multiple access to partitioned blocks of a shared memory and a portable terminal having the shared memory that can process data highly efficiently by eliminating the loss of time needed to communicate the data, stored in a specific memory, between processors.

Other objects of the present invention will become apparent through the preferred embodiments described below.

### [Technical Solution]

In order to achieve the above objects, an aspect of the present invention features a digital processing apparatus having a shared memory consisting of partitioned areas accessible by a plurality of processors.

The digital processing apparatus in accordance with a preferred embodiment of the present invention comprises: a memory unit, partitioned into a plurality of partitioned storage areas, the memory unit having a first port and a second port; a main processor, coupled to the first port through an MP (main processor)-ME (memory) bus and accessed to one of the partitioned storage areas through the MP-ME bus to write raw data and then outputting through an MP-AP (application processor) bus an order to process the raw data; and an application processor, coupled to the second port through an AP-ME bus and coupled to the main processor through the MP-AP bus, the application processor reading and processing the raw data through the AP-ME bus in accordance with the process order received through the MP-AP bus. Each of the partitioned storage areas is accessible by the application processor through the AP-ME bus and by the main processor through the MP-ME bus.

At least one of the plurality of partitioned storage areas can be assigned as a data delivery area for delivering data between the application processor and the main processor, and the raw data can be written in the data delivery area.

The process order can comprise instruction information on the process type of the raw data and a storage location of the raw data. The process order can further comprise location information for storing raw data processed to correspond to the instruction information.

In case one of the main processor and the application processor accesses one of the partitioned storage areas, access status information can be transmitted through the MP-AP bus to the other of the main processor and the application processor.

The area partition information corresponding to the size of the partitioned storage areas can be set by one of the main processor and the application processor and can be delivered to the other of the main processor and the application processor through the MP-AP bus.

The digital processing apparatus in accordance with another preferred embodiment of the present invention can comprise: a memory unit; an application processor, coupled to the memory unit through an AP (application processor)-ME (Memory) bus and processing and storing raw data stored in the memory unit accessed through the AP-ME bus in accordance with a process order; and a main processor, coupled to the memory unit through an MP (main processor)-ME bus and coupled to the application processor through an MP-AP bus to transmit the process order to the application processor through the MP-AP bus. A storage area of the memory unit can be partitioned to a plurality of partitioned storage areas that are accessible by the application processor through the AP-ME bus and by the main processor through the MP-ME bus, and the memory unit can comprise a first port, for communicating data with the application processor through the AP-ME bus, and a second port, for communicating data with the main processor through the MP-ME bus.

In case a first processor accesses any one of the partitioned storage areas, the first processor can transmit access status information to a second processor through the MP-AP bus. The first processor can be one of the main processor and the application processor, and the second processor can be the other of the main processor and the application processor.

In case the second processor attempts to access a partitioned storage area to write data while the first processor is accessed to the same partitioned storage area and is writing data, the memory unit can transmit an inaccessible message to the second processor. The first processor can be one of the main processor and the application processor, and the second processor can be the other of the main processor and the application processor.

The area partition information corresponding to the size of the partitioned storage areas can be set by the first processor, which is one of the main processor and the application processor, and can be transmitted to the second processor, which is the other of the main processor and the application processor, through the MP-AP bus.

The process order can comprise instruction information on the process type of the raw data and a storage location of the raw data. The process order can further comprise location information for storing raw data processed to correspond to the instruction information.

The plurality of partitioned storage areas can comprise a data delivery area for delivering data between the application processor and the main processor.

The digital processing apparatus in accordance with another preferred embodiment of the present invention can comprise: a memory unit, partitioned to a plurality of partitioned storage areas and having ports in a quantity of n, n being a natural number of 2 or larger; a main processor, coupled to a port of the memory unit through a first memory bus and accessed to one of the partitioned storage areas through the first memory bus to write raw data and then outputting through an MP-AP bus an order to process the raw data; and application processors in a quantity of n−1, the application processor coupled to a port of the memory unit through a second memory bus and coupled to the main processor through the MP-AP bus, the application processor reading and processing the raw data through the second memory bus in accordance with the process order received through the MP-AP bus. The main processor and the application processors in a quantity of n−1 can be independently coupled to each of the ports in a quantity of n, and each of the partitioned storage areas can be accessible by the application processor through the second memory bus and by the main processor through the first memory bus.

In order to achieve the above objects, another aspect of the present invention features a method for controlling the access by a plurality of processors to partitioned areas of a shared memory and/or a recorded medium recording the method.

According to a preferred embodiment of the present invention, the recorded medium tangibly embodies a program of instructions executable by a digital processing apparatus to execute a method for controlling multiple access to partitioned areas of a shared memory. The program is readable by the digital processing apparatus wherein the digital processing apparatus comprises a main processor and an application processor, the main processor being coupled to a memory unit through an MP-ME bus, the application processor being coupled to the memory unit through an AP-ME bus, the main processor and the application processor being coupled to each other through an MP-AP bus, a storage area of the memory unit being partitioned to a plurality of partitioned storage areas. The program executes the acts of: a first processor determining, in order to access one of the partitioned storage areas, whether a second processor is already accessed to the partitioned storage area, wherein the first processor is one of the main processor and the application processor, and the second processor is the other of the main processor and the application processor; the first processor accessing the partitioned storage area if the second processor is not accessed to the partitioned storage area; the first processor writing data in the accessed partitioned storage area; and the first processor terminating the access to the partitioned storage area.

In case the first processor accesses one of the partitioned storage areas, the first processor can transmit access status information to the second processor through the MP-AP bus.

In case the second processor attempts to access a partitioned storage area to write data while the first processor is accessed to the same partitioned storage area and is writing data, the memory unit can transmit an inaccessible message.

The area partition information corresponding to the size of the partitioned storage areas can be set by the first processor and can be transmitted to the second processor through the MP-AP bus.

### DESCRIPTION OF DRAWINGS

FIG. 1 shows a block diagram of a conventional mobile communication terminal having a camera function;

FIG. 2 shows a block diagram of an example of a conventional coupling structure between a main processor, an application processor and each memory;

FIG. 3 shows a block diagram of a coupling structure between a main processor, an application processor and a memory unit, in accordance with a preferred embodiment of the present invention;

FIG. 4 shows the partitioned state of the storage area of the memory unit in accordance with a preferred embodiment of the present invention;

FIG. 5 shows a flow chart of a processor accessing a partitioned storage area in accordance with a preferred embodiment of the present invention; and

FIG. 6 shows the partitioned state of the storage area of the memory unit in accordance with another preferred embodiment of the present invention.

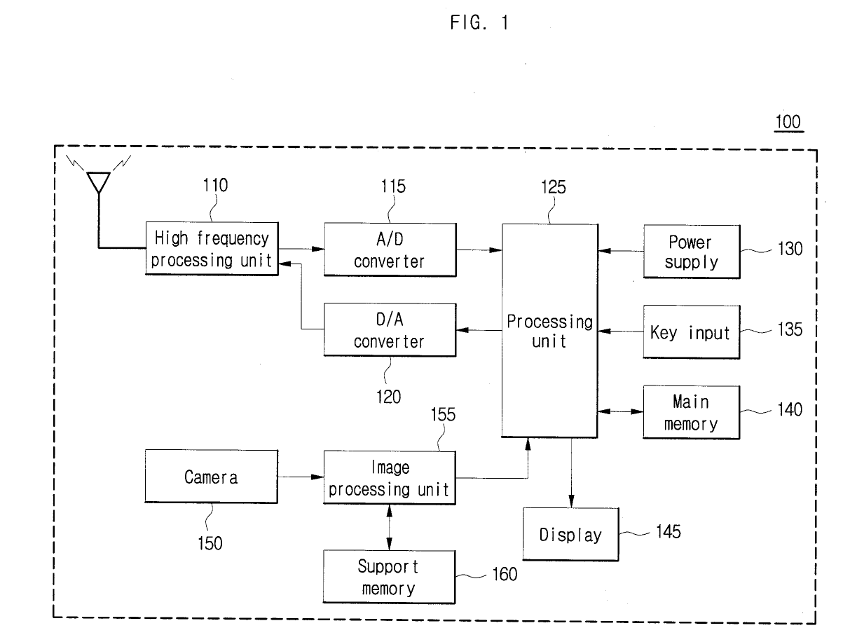

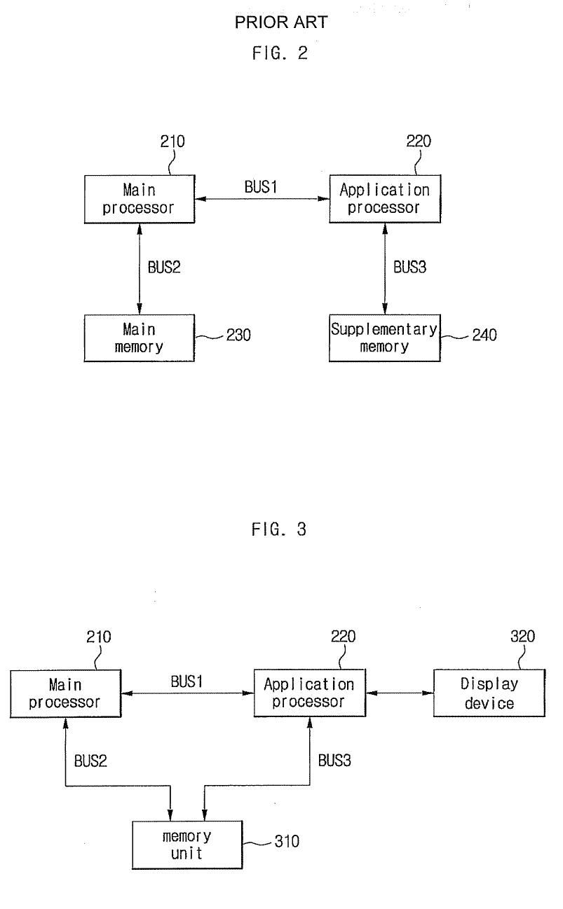

### DESCRIPTION OF KEY ELEMENTS

210: Main processor
220: Application processor
310: Memory unit

### MODE FOR INVENTION

The above objects, features and advantages will become more apparent through the below description with reference to the accompanying drawings.

Since there can be a variety of permutations and embodiments of the present invention, certain embodiments will be illustrated and described with reference to the accompanying drawings. This, however, is by no means to restrict the present invention to certain embodiments, and shall be construed as including all permutations, equivalents and substitutes covered by the spirit and scope of the present invention. Throughout the drawings, similar elements are given similar reference numerals. Throughout the description of the present invention, when describing a certain technology is determined to evade the point of the present invention, the pertinent detailed description will be omitted.

Terms such as “first” and “second” can be used in describing various elements, but the above elements shall not be restricted to the above terms. The above terms are used only to distinguish one element from the other. For instance, the first element can be named the second element, and vice versa, without departing the scope of claims of the present invention. The term “and/or” shall include the combination of a plurality of listed items or any of the plurality of listed items.

When one element is described as being “connected” or “accessed” to another element, it shall be construed as being connected or accessed to the other element directly but also as possibly having another element in between. On the other hand, if one element is described as being “directly connected” or “directly accessed” to another element, it shall be construed that there is no other element in between.

The terms used in the description are intended to describe certain embodiments only, and shall by no means restrict the present invention. Unless clearly used otherwise, expressions in the singular number include a plural meaning. In the present description, an expression such as “comprising” or “consisting of” is intended to designate a characteristic, a number, a step, an operation, an element, a part or combinations thereof, and shall not be construed to preclude any presence or possibility of one or more other characteristics, numbers, steps, operations, elements, parts or combinations thereof.

Unless otherwise defined, all terms, including technical terms and scientific terms, used herein have the same meaning as how they are generally understood by those of ordinary skill in the art to which the invention pertains. Any term that is defined in a general dictionary shall be construed to have the same meaning in the context of the relevant art, and, unless otherwise defined explicitly, shall not be interpreted to have an idealistic or excessively formalistic meaning.

Hereinafter, preferred embodiments will be described in detail with reference to the accompanying drawings. Identical or corresponding elements will be given the same reference numerals, regardless of the figure number, and any redundant description of the identical or corresponding elements will not be repeated.

Although it is evident that the method for sharing a memory in accordance with the present invention can be equivalently applied to all types of digital processing devices or systems (e.g. portable terminals and/or home digital appliances, such as the mobile communication terminal, PDA, portable multimedia player (PMP), MP3 player, digital camera, digital television, audio equipment, etc.), the portable terminal and two processors sharing a memory will be described hereinafter for the convenience of description and understanding. Moreover, it shall be easily understood through the below description that the present invention is not limited to a specific type of terminal or a memory having two ports but is applicable equivalently to any terminal having a plurality of processors and a shared memory.

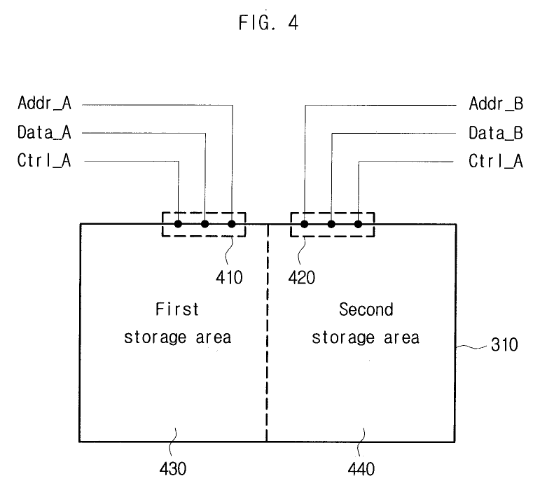

FIG. 3 is a block diagram showing a coupling structure between the main processor, the application processor and the memory unit, in accordance with a preferred embodiment of the present invention, and FIG. 4 shows the partitioned state of the storage area of the memory unit in accordance with a preferred embodiment of the present invention.

Referring to FIG. 3, the main processor 210 and the application processor 220 transmit and receive data (e.g. process order and status information) to and from each other through BUS 1 (i.e. an MP-AP (main processor-application processor) bus connecting the main processor 210 and the application processor 220). The main processor 210 and the memory unit 310 transmit and receive data to and from each other through BUS2 (i.e. an MP-ME (memory) bus connecting the main processor 210 and the memory 310). The application processor 220 and the memory unit 310 transmit and receive data to and from each other through BUS3 (i.e. an AP-ME bus connecting the application processor 220 and the memory unit 310). A bus refers to a common-purpose electric pathway that is used to transmit and receive information between the processor, the main memory and the input/output in a device such as a computer. Here, the main processor 210 can be a processor that controls the general operation of the portable terminal. Also, the application processor 220 can be a dedicated processor for processing the MPEG4, 3-D graphic and camera functions. The operation of the application processor 220 can be controlled by the main processor 210. A peripheral device such as a display device 320 can be coupled to the back of the application process 220. The kind of data to be outputted through the display device 320 can be controlled by the main processor 210 or the application processor 220.

The memory unit 310 is structured to be used by a plurality of processors coupled to the memory unit 310, and must have the same number of access ports corresponding to the number of processors equipped in the structure or sharing the memory unit 310.

For example, in a structure of the memory unit 310 coupled to both the main processor 210 and the application processor 220, as shown in FIGS. 3 and 4, the two processors 210 and 220 use one memory unit 310, thereby necessitating the memory unit 310 to have 2 access ports. In other words, the two access ports are configured to be identified as a first port 410 and a second port 420, having the first port and the second port connect to the main processor 210 and the application processor 220, respectively. Each of the main processor 210 and the application processor 220 can use an independent clock.

The storage area of the memory unit 310 can be partitioned to the number of partitions corresponding to the number of processors coupled to the memory unit 310. This is to allow each processor to access each partition at the same time to write data. For example, in case 2 processors are connected to the memory unit 310, as shown in FIG. 4, the memory unit 310 can be partitioned to 2 blocks (i.e. a first storage area 430 and a second storage area 440). Each of the partitioned blocks 430 and 440 can be individually accessed as long as it is not partitioned to be a dedicated block for a specific processor and it is not simultaneously accessed. This is to maintain the temporal consistency of the data consecutively by setting the process to complete one side before starting the next process. Of course, the memory unit 310 can be partitioned to more than 2 storage blocks even though only 2 processors are coupled to the memory unit 310.

The size of the partitioned block, that is, the first storage area 430 and the second storage area 440, of the memory unit 310 can be configured to be predetermined by default, partitioned to a certain size by the main processor 210 and/or the application processor 220, or varied whenever necessary (for example, when the data to be written is bigger than the writable area) by the main processor 210 and/or the application processor 220. In other words, the address information on the partitioned storage area of the memory unit 310 can be set and managed by the main processor 210, and the address information set by the main processor 210 is provided to and shared by the application processor 220. Of course, the address information can also be set and managed by the application processor 220, and, as necessary, one of the processors can have an address setting authority to supply the set address information to the other processor to have the address information shared. In this case, the information on the partitioned storage area of the memory unit 310 can be recognized by each processor when the portable terminal is booted.

The storage area can be partitioned in units of bank in case the memory is an SDRAM. An SDRAM usually comprises an RAS address, a CAS address and a Bank address, and it is common that there are 4 banks. Here, the 4 banks can be grouped in two to have each group assigned as the first storage area 430 and the second storage area 440, respectively.

Although FIG. 4 shows the first port 410 on the first storage area 430 side and the second port 420 on the second storage area 440 side, this is only for the convenience of illustration and does not mean that only the storage area of one side is accessible by each of the port 410 and 420. Therefore, it should be evident that any of the storage areas 430 and 440 can be accessed by each of the ports 410 and 420. However, as described earlier, if one of the processors is accessed to one of the storage areas in order to write data, the other processor must be restricted from accessing the storage area.

Although not illustrated, the memory unit 310 can further comprise an internal controller for controlling internal operation. In case the first processor (i.e. one of the main processor 210 and the application processor 220) is accessed to one storage area and is writing data, and the second processor (i.e. the other of the main processor 210 and the application processor 220) is attempting to access the same storage area for writing data, the internal controller can send a n inaccessible message to the second processor. The inaccessible message can be a predetermined signal outputted through a predetermined pin. This is because the internal controller can recognize the storage area that a particular processor has accessed or is trying to access.

The plurality of processors 210 and 220 can be restricted from simultaneously accessing the first storage area 430 or the second storage area 440 by having the first accessed processor notify the other processor of the access (e.g. accessed address information) or having the memory unit 310 notify the other processor of the access if one of the processors accesses the shared area. In other words, it is possible for the main processor 210 and the application processor 220 to process data by simultaneously accessing the memory unit 310 through independent routes, and in this case collision between the two processors can be prevented.

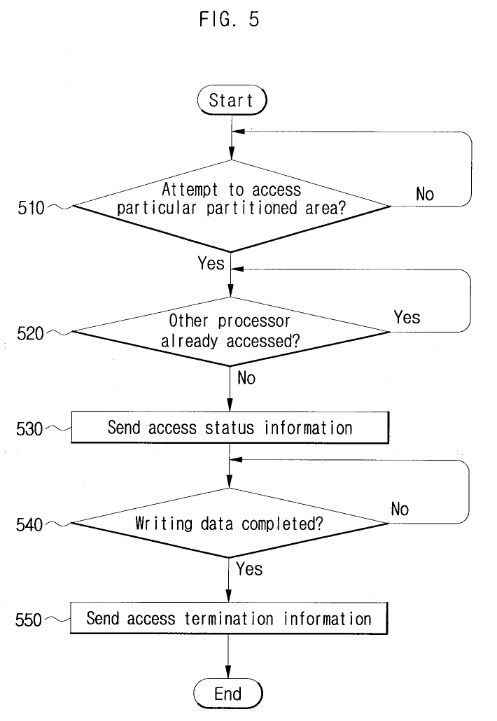

FIG. 5 is a flowchart of a processor accessing the partitioned storage area in accordance with a preferred embodiment of the present invention.

The storage area of the memory unit 310 of the present invention can be partitioned to a plurality of partitioned storage areas 430 and 440, and each processor can write or read data by accessing one of the partitioned storage units through an access port. In other words, while the main processor 210 is accessed to the first storage area 430, the application processor 220 can freely access the second storage area 440. Therefore, each processor can simultaneously access each partitioned storage area of the memory unit 310 to perform the necessary data process. If a plurality of processors are accessed to one partitioned storage area simultaneously, however, the data consistency can be damaged, for which a preventive measure is required. Of course, it may be allowed to have one processor write data while the other processor read data although a plurality of processors are accessed to the same partitioned storage area at the same time. Below, a method for not allowing a plurality of processors to access the same partitioned storage area will be described with reference to FIG. 5.

Referring to FIG. 5, in step 510, it is determined whether a processor (i.e. one of the main processor 210 or the application processor 220, hereinafter referred to as “first processor”) is to access a particular partitioned storage area (i.e. the first storage area 430 or the second storage area 440).

If there is no need to access the partitioned storage area, step 510 is repeated.

If the partitioned storage area needs to be accessed, however, the first processor determines, in step 520, whether the other processor (i.e. the other of the main processor 210 and the application processor 220, hereinafter referred to as “second processor”) is already accessed to the partitioned storage area. The access by the second processor to a partitioned storage area can be recognized through status information received from the corresponding processor or the memory unit 310.

If the second processor is accessed to the partitioned storage area, the process waits in step 520 until the second processor terminates its access to the pertinent partitioned storage area.

If the partitioned storage area is accessible, however, the first processor accesses the partitioned storage area, in step 530, and sends access status information, indicating the access by the first processor to the partitioned storage area, to the second processor. The access status information can be transmitted immediately before the access to the partitioned storage area, or can be transmitted to the second processor by the memory unit 310 as described above.

In step 540, the first processor determines whether the data to be written is completely stored in the accessed partitioned storage area. If the data to be written is not completely written, the pertinent data keeps being written, but if the data is completely written, the access to the pertinent partitioned storage area is terminated in step 550. Furthermore, the first processor or the memory unit 310 sends access termination information of the partitioned storage area to the second processor to enable the access by the second processor.

As described above, the method for sharing the partitioned storage area in accordance with the present invention can allow the main processor 210 and the application processor 220 to cross-access a plurality of partitioned storage areas, thereby making the real-time data delivery possible by writing the data to be delivered to the other processor in a specific area of each partitioned storage area and providing the authority to access the pertinent partitioned storage area to the other processor. Therefore, a prompt process becomes possible when the application processor 220 processes data in accordance with a process order by the main processor 210. In this case, the storage address information of the data can be delivered to the other processor, if necessary.

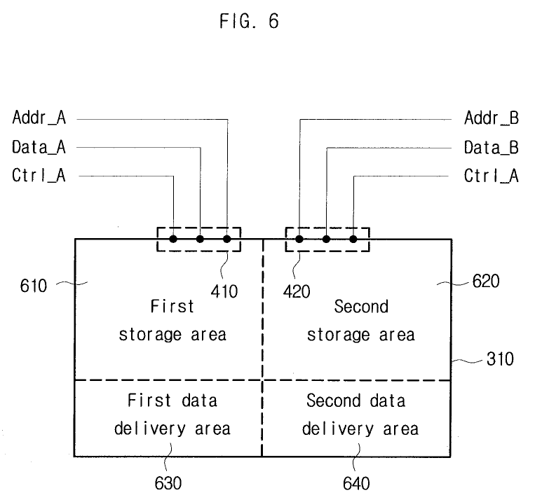

FIG. 6 shows the partitioned state of the storage area of the memory unit in accordance with another preferred embodiment of the present invention.

As illustrated in FIG. 6, the storage area of the memory unit 310 can be partitioned to a plurality of storage areas (i.e. a first storage area 610, a second storage area 620, a first data delivery area 630 and a second data delivery area 640).

As illustrated in FIG. 4 earlier, in the method of partitioning the storage area of the memory unit 310 into the first storage area 410 and the second storage area 420 only, in order for the first processor (i.e. either the main processor 210 or the application processor 220) to allow the second processor (i.e. the other of either the main processor 210 or the application processor 220) to use the pertinent data when the first processor has written the data in a partitioned storage area, the access to the pertinent partitioned storage area must be terminated.

If, as in FIG. 6, separate data delivery areas 630 and 640 are equipped although a large amount of data is to be transferred between the main processor 210 and the application processor 220, as in the case of a graphic process, the data to be delivered between each processor can be transferred or copied to a data delivery area corresponding to each storage area, and then only the information needed for accessing the pertinent data delivery area can be delivered to the other processor, thereby eliminating the need to surrender the authority to access the pertinent storage area 610 or 620. After the data to be delivered to the other processor is stored in a data delivery area, the pertinent processor delivers the storage location information and a process order (e.g. instruction for process type of the pertinent data) of the pertinent data to the other processor through a corresponding bus. Of course, the storage location information can be omitted if there is a default storage address in data delivery area. As such, by exchanging the authority to access the storage area, in which data is stored, between a plurality of processors, the data communication time for processing data can be saved.

Of course, in case a small amount of data is to be transmitted between a plurality of processors, the data can be communicated through a bus connected between each processor although the access to the pertinent partitioned storage area is not terminated.

The drawings and detailed description are only examples of the present invention, serve only for describing the present invention and by no means limit or restrict the spirit and scope of the present invention. Thus, any person of ordinary skill in the art shall understand that a large number of permutations and other equivalent embodiments are possible. The true scope of the present invention must be defined only by the spirit of the appended claims.

### INDUSTRIAL APPLICABILITY

As described above, the present invention can minimize the data transmission time between processors by partitioning the storage area of the shared memory into a plurality of partitioned blocks and allowing the plurality of processors to access each partitioned block.

The present invention can also allow each processor to handle its dedicated process to optimize the operation speed and efficiency of each processor by allowing partitioned storage areas of the shared memory to be accessed by a plurality of processors.

Moreover, the present invention can easily control the shared memory in software, by using partitioned blocks of the shared memory.

Furthermore, the present invention can process data highly efficiently by eliminating the loss of time needed to communicate the data, stored in a specific memory, between processors.

What is claimed is

1. A digital processing apparatus comprising:
a memory unit, the memory unit being configured to be partitioned into a plurality of partitioned storage areas, the memory unit having a first port and a second port;
a main processor, operatively coupled to the first port through an MP (main processor)-ME (memory) bus for accessing to at least one of the partitioned storage areas through the MP-ME bus to write raw data and then outputting through an MP-AP (application processor) bus an order to process the raw data; and
an application processor, operatively coupled to the second port through an AP-ME bus for accessing to at least one of the partitioned storage areas through the AP-ME bus and coupled to the main processor through the MP-AP bus, the application processor reading and processing the raw data through the AP-ME bus in accordance with the process order received from the main processor through the MP-AP bus.

2. The digital processing apparatus of claim 1, wherein:
at least one of the plurality of partitioned storage areas is assigned as a data delivery area for delivering data between the application processor and the main processor; and the raw data is written in the data delivery area.

3. The digital processing apparatus of claim 1, wherein the process order comprises instruction information on the process type of the raw data and a storage location of the raw data.

4. The digital processing apparatus of claim 3, wherein the process order further comprises location information for storing raw data processed to correspond to the instruction information.

5. The digital processing apparatus of claim 1, wherein, in case one of the main processor and the application processor accesses one of the partitioned storage areas, access status information is transmitted through the MP-AP bus to the other of the main processor and the application processor.

6. The digital processing apparatus of claim 1, wherein area partition information corresponding to the size of the partitioned storage areas is set by one of the main processor and the application processor and is delivered to the other of the main processor and the application processor through the MP-AP bus.

7. A digital processing apparatus comprising:
a memory unit;
an application processor, operatively coupled to the memory unit through an AP (application processor)-ME (Memory) bus and processing and storing raw data stored in the memory unit accessed through the AP-ME bus in accordance with a process order; and
a main processor, operatively coupled to the memory unit through an MP (main processor)-ME bus and operatively coupled to the application processor through an MP-AP bus to transmit the process order to the application processor through the MP-AP bus,
wherein a storage area of the memory unit is partitioned to a plurality of partitioned storage areas that are accessible by the application processor through the AP-ME bus and by the main processor through the MP-ME bus, and
the memory unit comprises a first port[[,]] for communicating data with the application processor through the AP-ME bus, and a second port[[,]] for communicating data with the main processor through the MP-ME bus.

8. The digital processing apparatus of claim 7, wherein, in case a first processor accesses any one of the partitioned storage areas, the first processor transmits access status information to a second processor through the MP-AP bus, whereas the first processor is one of the main processor and the application processor, and the second processor is the other of the main processor and the application processor.

9. The digital processing apparatus of claim 7, wherein in case the second processor attempts to access a partitioned storage area to write data while the first processor is accessed to the same partitioned storage area and is writing data, the memory unit transmits an inaccessible message to the second processor, whereas the first processor is one of the main processor and the application processor, and the second processor is the other of the main processor and the application processor.

10. The digital processing apparatus of claim 7, wherein area partition information corresponding to the size of the partitioned storage areas is set by the first processor, which is one of the main processor and the application processor, and is transmitted to the second processor, which is the other of the main processor and the application processor, through the MP-AP bus.

11. The digital processing apparatus of claim 7, wherein the process order comprises instruction information on the process type of the raw data and a storage location of the raw data.

12. The digital processing apparatus of claim 11, wherein the process order further comprises location information for storing raw data processed to correspond to the instruction information.

13. The digital processing apparatus of claim 7, wherein the plurality of partitioned storage areas comprise a data delivery area for delivering data between the application processor and the main processor.

14. A digital processing apparatus comprising:
a memory unit, configured to be partitioned to a plurality of partitioned storage areas and having ports in a quantity of n, n being a natural number of 2 or larger;
a main processor, operatively coupled to a port of the memory unit through a first memory bus for accessing to one of the partitioned storage areas through the first memory bus to write raw data and then outputting through an MP-AP bus an order to process the raw data; and
application processors in a quantity of n−1, the application processor coupled to a port of the memory unit through a second memory bus and coupled to the main processor through the MP-AP bus, the application processor reading and processing the raw data through the second memory bus in accordance with the process order received through the MP-AP bus, wherein the main processor and the application processors in a quantity of n−1 are independently coupled to each of the ports in a quantity of n, and each of the partitioned storage areas is accessible by the application processor through the second memory bus and by the main processor through the first memory bus.

15. A recorded medium tangibly embodying a program of instructions executable by a digital processing apparatus to execute a method for controlling multiple access to partitioned areas of a shared memory, the program readable by the digital processing apparatus, wherein the digital processing apparatus comprises a main processor and an application processor, the main processor being coupled to a memory unit through an MP-ME bus, the application processor being coupled to the memory unit through an AP-ME bus, the main processor and the application processor being coupled to each other through an MP-AP bus, a storage area of the memory unit being partitioned to a plurality of partitioned storage areas, the program executing the acts of:
a first processor determining, in order to access one of the partitioned storage areas, whether a second processor is already accessed to the partitioned storage area, wherein the first processor is one of the main processor and the application processor, and the second processor is the other of the main processor and the application processor;
the first processor accessing the partitioned storage area if the second processor is not accessed to the partitioned storage area;
the first processor writing data in the accessed partitioned storage area; and
the first processor terminating the access to the partitioned storage area.

16. The recorded medium of claim 15, wherein, in case the first processor accesses one of the partitioned storage areas, the first processor transmits access status information to the second processor through the MP-AP bus.

17. The recorded medium of claim 15, wherein in case the second processor attempts to access a partitioned storage area to write data while the first processor is accessed to the same partitioned storage area and is writing data, the memory unit transmits an inaccessible message.

18. The recorded medium of claim 15, wherein area partition information corresponding to the size of the partitioned storage areas is set by the first processor and transmitted to the second processor through the MP-AP bus.
